(19) United States
(12) Patent Application Publication
(10) Pub. No.: US 2017/0311664 A1
(43) Pub. Date: Nov. 2, 2017

(54) Multiuse Glove with Impact Protection and Ratchet

(71) Applicants: Rafael A. Calvo, Altadena, CA (US); Janet Ellis Calvo, Altadena, CA (US); William Richards, La Crescenta, CA (US)

(72) Inventors: Rafael A. Calvo, Altadena, CA (US); Janet Ellis Calvo, Altadena, CA (US); William Richards, La Crescenta, CA (US)

(21) Appl. No.: 15/144,793

(22) Filed: May 2, 2016

(51) Int. Cl. A41D 19/00; B25B 13/46

(52) U.S. Cl. CPC A41D 19/0024; B25B 13/468; A41D 19/002; B25B 13/467; A41D 2600/20

(57) ABSTRACT

A surface covering the palm, backside, index and other fingers of the hand including a wrist shroud; a repositionable flap attached transversely between the wrist and palm portions of the glove, said flap having a pocket, said pocket holding a plate made of a suitably hard material; a flap securing means allowing the flap to be secured against the wrist when not in use or against the palm of the hand for striking objects; a detachable, reversible ratchet driver disposed along the backside of the index finger in alignment with the long axis of the hand, said ratchet including a cylindrical body, a toggle button forward and reverse mechanism as used in ink pens, ratchet means and a coupler for receiving common tool bits for Philips, flat head, hex, star, Allen, socket and other fasteners of the like.

### SUMMARY OF THE INVENTION

The glove of the present invention resembles a typical work glove, being of sturdy construction and covering the user's hand and wrist. This invention provides solutions for two common needs that are otherwise only met by act of grasping for other separate tools:

First, the typical work glove does not provide enough protection when a user deliberately strikes an object with the ball of the hand as can be needed often when working with and constructing large wood or metal objects, when working with chisels, or at times when the action requires nudges of the material being worked during assembly. Because of the lack of adequate protection in a typical glove, striking an object with a gloved hand can still allow the user's hand to be bruised or hurt when the ball of the hand is used as a mallet. Some work gloves have added extra padding to the ball area of the glove. However, were the glove to have a permanently placed, rigid, thick piece of protective material covering the ball of the hand as the prior art teaches, the rigid material impedes the closure of the hand for grasping objects. Many other examples of prior art, for example U.S. Pat. No. 8,935,812, show gloves with some protection but these nonetheless provide insufficient protection against deliberate and forceful impact by the user onto an object. U.S. Pat. No. 8,758,541 teaches a removable wrist protection device but the protection is incorporated into the body of the device in such a way that removing the device leaves the hand with no protection at all and there is no indication that a user would wear such a wrist protection device over another glove.

This invention provides a flap with the rigid protective piece of material encased in the flap. In a preferred embodiment, the protective piece is a molded sheet metal which forms a shallow “V” shaped plate generally conforming to the two lobes of the ball of the hand. Alternatively, a hard rubber or plastic material would also make for a suitable plate that would provide the type of desired protection. With additional padding placed between the plate and the outer side of the flap the user is significantly protected even when striking a blow with the ball of the hand. Velcro pads connected to the flap, and to the body of the glove, hold the flap in a first position against the wrist shroud and when the flap is turned to a second position the flap remains firmly affixed on the ball area of the hand via the Velcro pad sewn into the ball portion of the glove. Thus, the user may choose to easily and securely cover the ball of the hand with the flap when striking an object or position the flap away from the ball of the hand to allow for gripping an object.

Second, there often exists a need to drive a fastener such as a screw or nut into an object while wearing gloves. Wearing a glove can make starting a small fastener so difficult that the wearer is required to remove the glove. Having a reversible ratchet driver incorporated into the glove, the user can hold the fastener with one hand and immediately turn the fastener with the other without having to reach for a different tool or remove the glove to grip the fastener. This makes engaging the fastener into a hole or against a nut a quicker and easier process.

A first embodiment of the ratchet driver consists of a cylindrical body, a retracting toggle button, a ratchet, and a means for locking the ratchet in a forward or reverse direction using opposing pawls situated to engage a gear respectively, and a driver fitting for receiving common tool bits for Philips, flat head, hex, star, Allen and other fasteners of the like.

Situated at the end of the cylindrical body farthest from the fingertips, the driver uses a toggle button and follower cam mechanism as is used with retractable pens. When the button is at a first position, the ratchet means is locked to turn a fastener in a counterclockwise rotation (loosening the fastener). When the button is pressed into the cylindrical body, it moves inward and the cam locks in a second position. With the toggle button mechanism set in the second position, the ratchet means locks for clockwise rotation (tightening a fastener).

A pawl shaft is positioned coaxially to the cam and has a first end situated to fit in a depression in the middle of the cam as is commonly done with ink cartridges in retractable pens. A gear, situated along the shaft and secured hereto, is slaved to turn with the shaft and if further restricted against the shaft such that when the shaft moves forward and backward, the gear moves with the shaft as well. At least two pawls are secured to the cylindrical body. In a preferred embodiment two sets of the pawls are used. The pawls are situated such that the gear only engages one set of the pawls at any one time. Each set of pawls, located at opposite sides of the body, and in line with each other, is designed to restrict the rotation direction of the gear in one direction—one set restricts clockwise rotation while the second set restricts counterclockwise rotation. When the gear, which generally resembles the shape of a rugby ball, moves forward or backward, its tapered shape permits the pawls to be easily lifted and engage on or disengage from the tooth portion of the gear.

A second end of the shaft, situated opposite the end in the follower cam, is connected to a standard female hexagonal driver coupler which receives hexagonal driver bits common in the industry. A “C” ring holds the coupler in place. A first pawl is attached to the first pawl holder on the side of the gear closest to the button. A second pawl, attached to the second pawl holder, is in alignment with the first pawl and mirrors the first pawl in shape and position. Said second pawl is situated on the opposite side of the gear. When the button is in a first position, the second pawl, connected to the second pawl holder, engages the gear while the first pawl is separated from the gear, thus restricting free movement of the gear whenever counterclockwise rotational force is applied to the cylindrical body, thus the coupler spins with the rotation as well. However, when clockwise rotational force is applied to the cylindrical body, the gear and coupler spin freely. When the button is in the second position, the first pawl, connected to the first pawl holder, engages the gear while the second pawl is separated from the gear, thus restricting free movement of the gear whenever clockwise rotational force is applied to the cylindrical body thus the coupler spins with the rotation as well. However, when counterclockwise rotational force is applied to the cylindrical body, the gear and coupler spin freely.

Therefore, when the button is in the first position the mechanism is used to loosen a fastener, and when the button is depressed into the body to the second position, the mechanism is used to tighten a fastener. Upon depressing the button again, the gear moves back to its first position. By “clicking” the button at will, the user can easily and quickly switch between the first and second position. Tension springs keep pressure on the follower cam to spin about the long axis of the main body by one tooth each time the button is depressed as is done with common retractable pens. Unlike a retractable pen, however, this action of the button and cam moves the engagement position of the gear and pawls to function as a dual-setting switch. Whereas most ratchet wrenches use either a lever or a small knob only capable of moving from a first setting or a second setting, and whereas these levers and knobs are small and would be difficult to operate with a glove covering the hand, the push button of this invention permits the user to easily operate the single push button actuator even with the gloves on.

A second embodiment of the ratchet driver also consists of a cylindrical body, a toggle button, a ratchet, and a means for locking the ratchet in a forward or reverse direction using opposing pawls situated to engage a gear respectively, and a driver fitting for receiving sockets. Unlike the first embodiment that has the coupler coaxially situated with the long axis of the body, in the second embodiment the coupler is transversely situated with the long axis of the body. With this embodiment there is not a gear slaved on the pawl shaft. Here a sprocket gear is situated behind and coaxially to the coupler and is attached with a sprocket shaft such that both the sprocket and the coupler spin together. Inside the body of the cylinder, the pawl shaft is connected to a pawl holder. The pawl holder straddles the sprocket gear shaft and terminates on the other side. Two pawls located on the pawl holder, one on each side of the sprocket gear engage the sprocket gear independently depending on whether the button mechanism is in the first position or the second position.

### Multi-Use Glove with Impact Protection and Ratchet

### FIELD OF THE INVENTION

The present invention generally relates to gloves designed to protect the hand, more particularly, to a glove that can directly and safely impart a kinetic force on an object as well as to turn a fastener such as a screw, bolt, nut or socket without having to reach for a screwdriver or ratchet wrench.

### BACKGROUND OF THE INVENTION

Gloves have been developed to protect the hand from dangers such as being cut and having abrasions. Some gloves include padding and/or other materials to further protect against impacts. However, these protection devices have been created with a defensive objective. By contrast, the current invention permits the wearer to impart direct kinetic force on an object without damaging the hand or the object stricken. The flap, consisting of a suitably hard material and padding, is set in a first position protecting the ball portion of the hand allowing a user to easily strike an object as desired. Further, the flap can be moved in a second position out of the way when not in use. When using a hammer or mallet, a user may have difficulty controlling the amount of kinetic force transferred onto an object, cannot easily determine the amount of force required to move an object, or risks denting or damaging the object by striking it with a hammer. These problems occur, for instance, when using a chisel; or when trying to nudge a wood beam into position during a construction project; or building a piece of furniture.

Additionally, a user may have need of turning a fastener such as a screw, bolt, nut or socket while wearing a glove but may find reaching for a screwdriver or ratchet wrench difficult or impractical. Common ratchet devices provide a lever or small tooth that the user must move to reverse the direction of the locking mechanism of the ratchet. In order to manipulate the lever a user may have difficulty operating the lever and may be required to remove the glove. If removing the glove is not possible or impractical, then the user must hold the ratchet with one gloved hand while moving the lever with another pointy tool in the other gloved hand. Having a toggle button reversible driver, literally at one's fingertip, solves this issue. Electricians, for example, who regularly work in cramped crawl spaces while wearing gloves, have use of a glove that provides these features incorporated into it while still also having the ability to adequately grip objects without restriction.

OBJECTS OF THE INVENTION

It is the object of this invention to provide protection for the user's hands while allowing the user to safely impart mallet-like kinetic force on objects that need to be struck.

A further object of this invention is to provide a reversible ratchet mechanism incorporated into the glove allowing a user to turn a fastener without the need to reach for a separate driver or ratchet tool.

It is also the object of this invention to provide a reversible ratchet mechanism that is operated by a single toggle-action button mechanism; that mechanism being easily pressed from a first position to a second position and then again back to a first position all the while without having to remove the glove to operate the reversing ratchet mechanism.

Another object of this invention is to have a plurality of ratchet mechanisms be interchangeable on the glove to provide multiple types of ratchets for varying types of fastening requirements.

Still another object of this invention is to have ratchet tool that can be used independently of the glove.

### BRIEF DESCRIPTION OF THE DRAWINGS

FIGS. 1 and 2 are perspective views of the palm side of the glove. FIG. 1 is a general view of the glove with the flap is in a first at rest position covering the wrist.

FIG. 2 is a general view of the glove with the flap is in a second position positioned over the palm of the hand ready for use.

FIG. 3 is a perspective view of the backside of the glove with the metal plate and ratchet mounting bracket.

FIGS. 4 and 5 are perspective views of the backside of the glove with the ratchet drivers attached to the mounting bracket.

FIG. 4 is a side perspective view of the ratchet driver with a coaxial coupler on the backside of the glove.

FIG. 5 shows the ratchet driver with the transversely mounted coupler on the backside of the glove.

FIGS. 6 and 7 are side perspective views of the cylinder body with the coaxial coupler.

FIG. 8 is a side perspective, inside view of the cylinder body with each of the internal parts exploded with each part identified.

FIGS. 9 and 10 are side perspective, inside exposed views of the cylinder body. FIG. 9 shows the button, cam, pawl shaft and gear in the first position. FIG. 10 shows the button, cam, pawl shaft and gear depressed into the body in the second position.

FIG. 11 is a side perspective view of the cylinder body with the transversely mounted coupler.

FIG. 12 is a side perspective, inside view of the cylinder body with each of the internal parts exploded with each part identified.

FIG. 13 is a bottom sectional inside exposed view of the cylinder body with the button, cam pawl shaft and pawl holder in the first position.

FIG. 14 is a bottom sectional inside exposed view of the cylinder body with the button, cam pawl shaft and pawl holder in the second position.

FIG. 15 is a bottom sectional inside detailed exposed view of the cylinder body more clearly depicting the pawl and sprocket connection in the first position.

FIG. 16 is a bottom sectional inside detailed exposed view of the cylinder body more clearly depicting the pawl and sprocket connection in the second position.

### DETAILED DESCRIPTION OF THE DRAWINGS

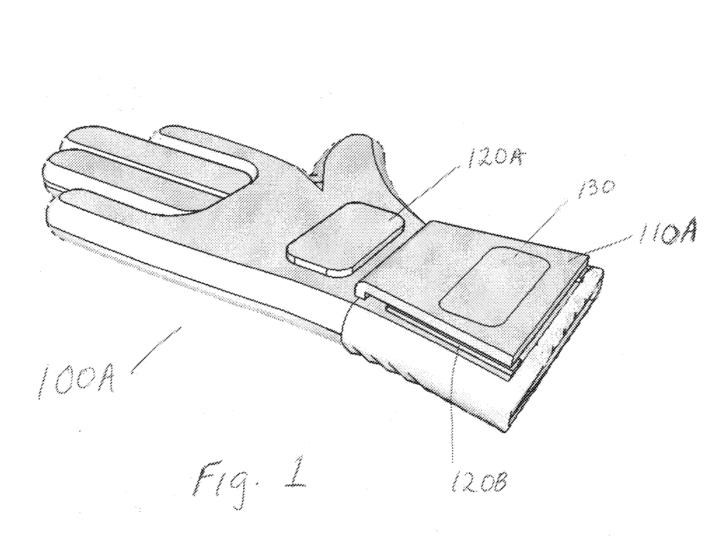

Referring to the drawings, in particular to FIG. 1, there is shown generally at (100A) a glove, palm side up, incorporating the features of the invention that have been disclosed on the palm side of the glove. A flap (110A) is in a first at rest position covering the wrist. Within flap (110A) is situated a metal insert (130). A Velcro patch (120A) is situated generally over the palm area of the glove. Just barely visible, is a second Velcro patch (120B) which secures flap (110A) when at rest.

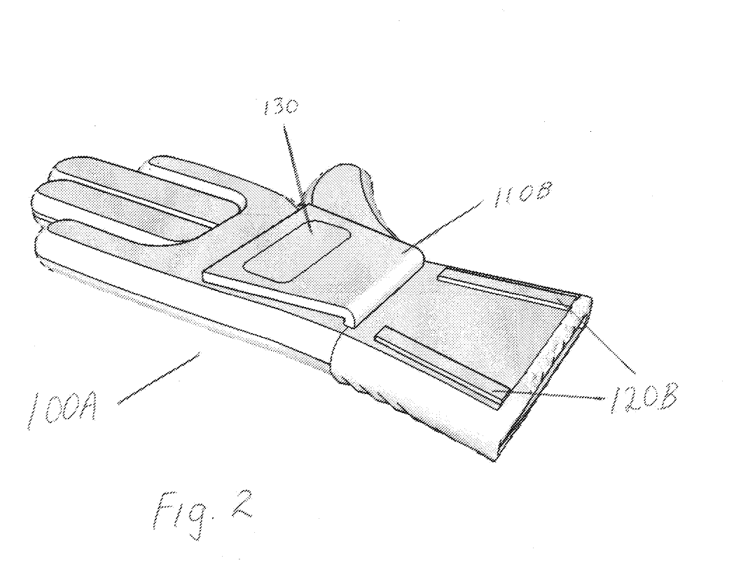

Referring now to FIG. 2, there is shown a general view of glove (100A) with flap (110B) in a second position, secured over the palm of the hand by Velcro (120A). Metal plate (130) is now in position in front of the palm for safely striking an object.

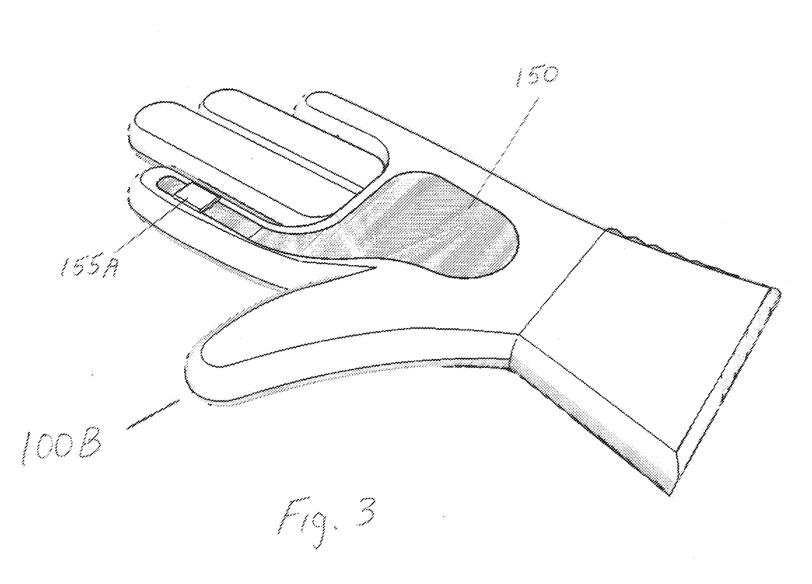

Referring now to FIG. 3, there is shown a perspective view of the backside of glove (100B) with metal plate (150) placed along and inside the index finger and the back portion or the hand area. Plate (150) is able to flex as the wearer closes his/her hand. Ratchet mounting bracket (155) is securely coupled to plate (150).

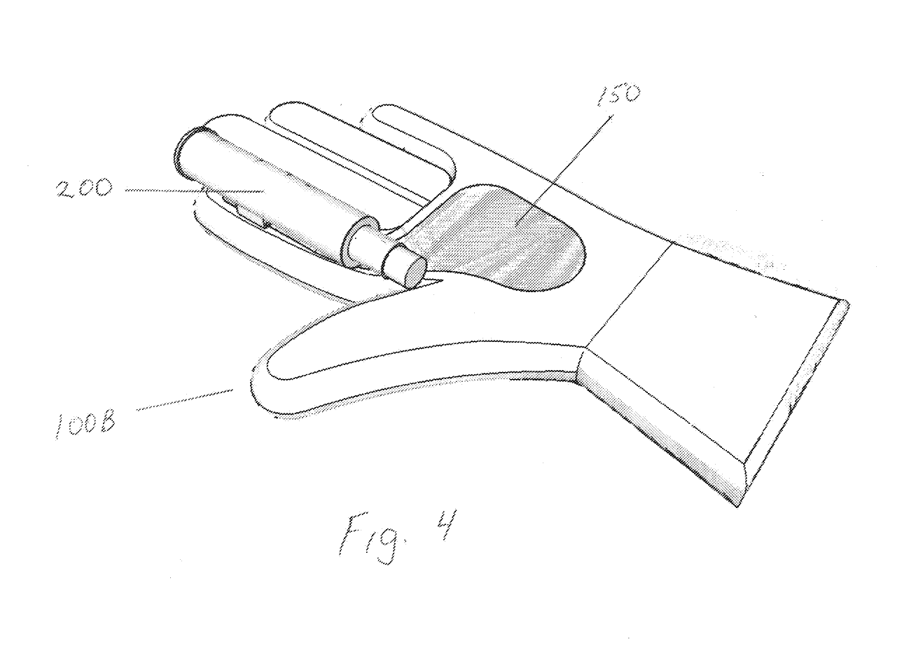

Referring now to FIG. 4, there is shown a perspective view of the backside of glove (100B) with ratchet driver (200) attached to mounting bracket (155).

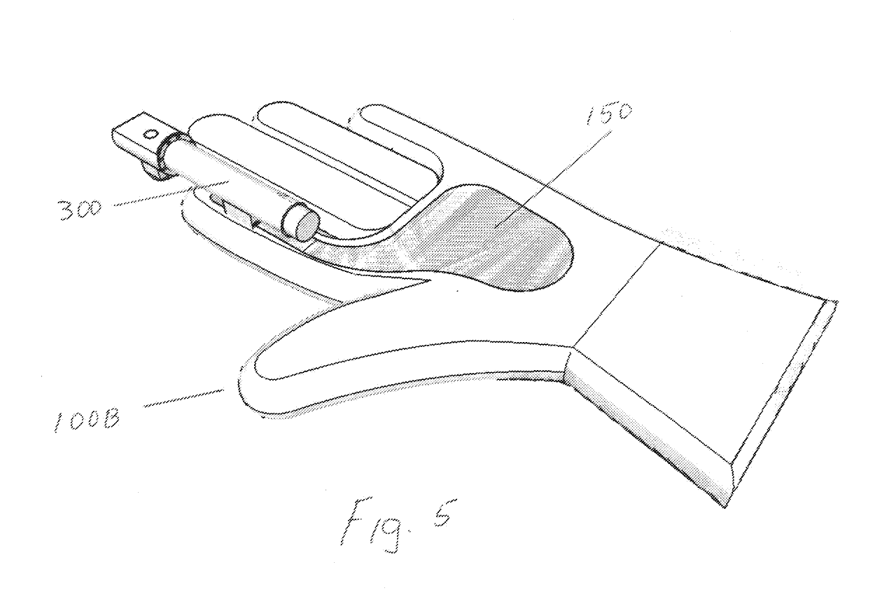

Referring now to FIG. 5, there is shown a perspective view of the backside of glove (100B) with ratchet wrench (300) attached to mounting bracket (155).

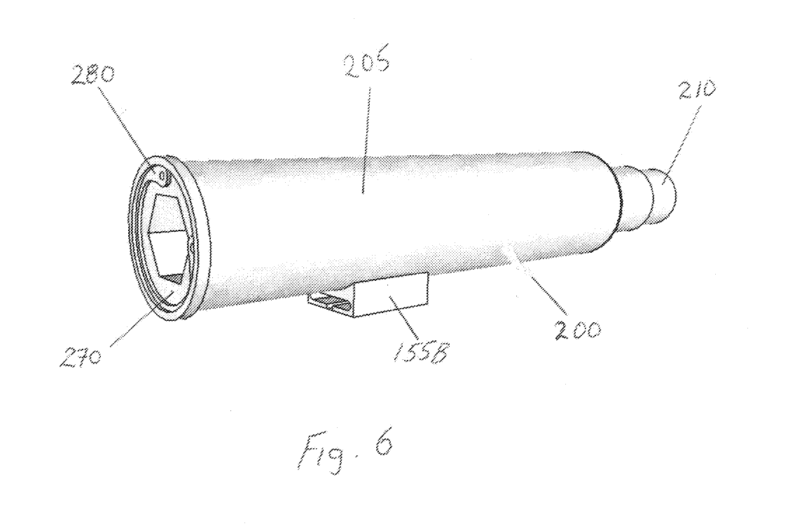

Referring now to FIG. 6, there is shown a side frontal perspective view of cylinder body (200) with coupler (270) coaxially situated at the fingertip end of cylinder (200). C-clip (280) secures coupler (270) within cylinder (200).

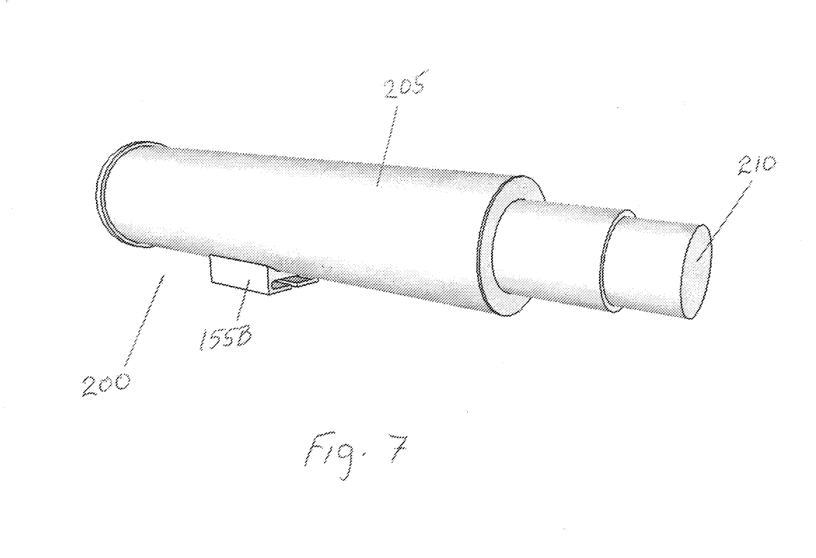

Referring now to FIG. 7, there is shown a side rearward perspective view of cylinder body (200) with toggle button (210) coaxially situated at the other end of cylinder (200).

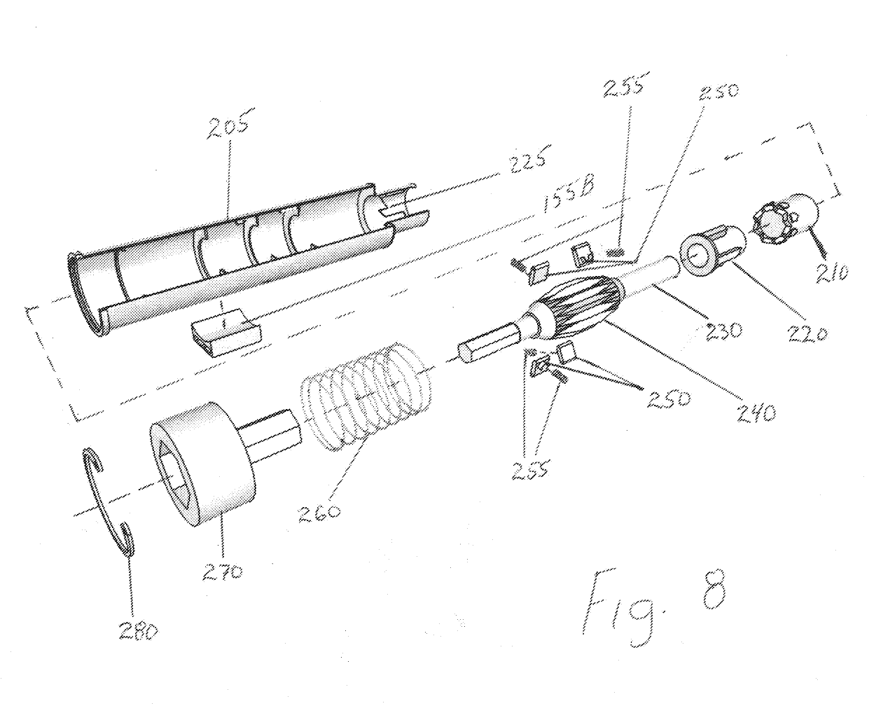

Referring now to FIG. 8, there is shown a side perspective, inside view of a cutaway cylinder body (205) with each internal part exploded and indicating the progression of parts within cylinder (205) Beginning with toggle button (210), it engages teeth (225) at the end of cylinder (205). The tip of cam (220) is placed coaxially within the hollow center of button (210). The teeth of cam (220) engage the teeth of button (210). Whereas button (210) does not spin, cam (220) will spin clockwise the amount of one tooth each time button (210) is depressed into cylinder (200).

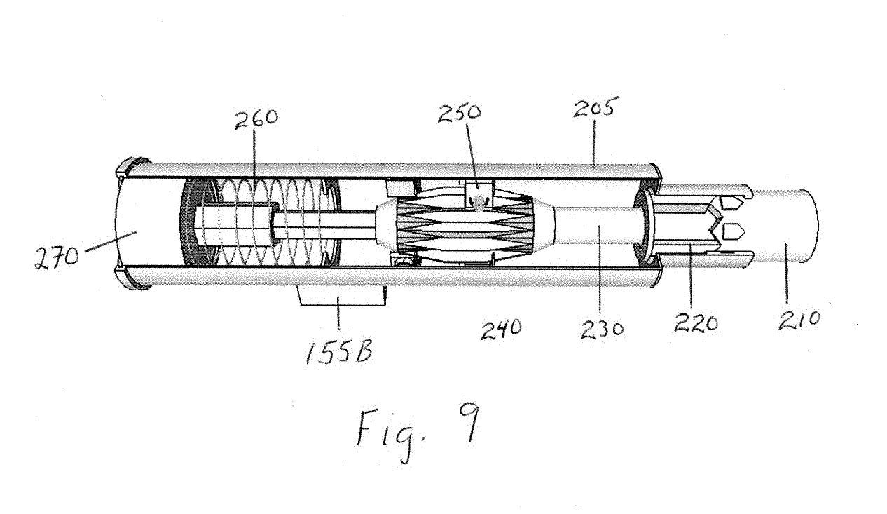

Now referring to FIG. 9, there is shown a side perspective, inside exposed view of cylinder body (205) with the device in the “at rest” position. Button (210) protrudes outward of cylinder (205) to its maximum amount. One end of shaft (230) is situated inside of cam (220) and is shown with pawl gear (240) engaging the pawl (250) nearest cam (220). Main spring (260) provides constant rearward tension on shaft (230), cam (220) and button (210).

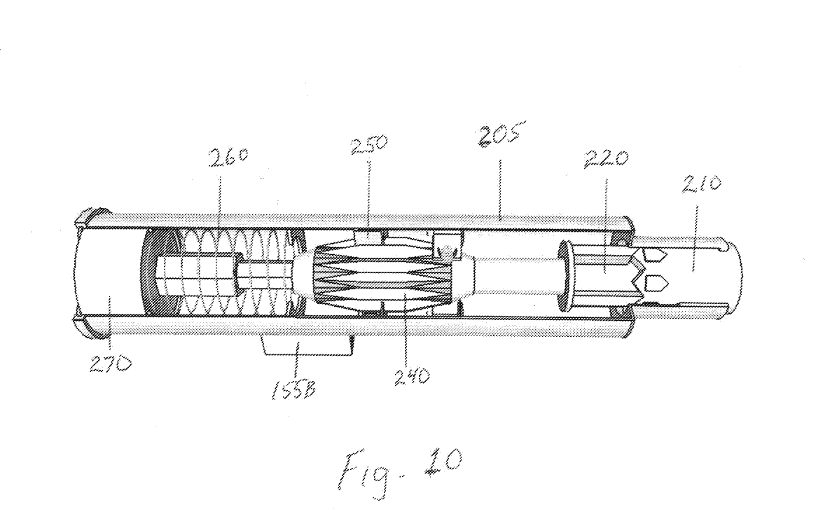

Referring now to FIG. 10, there is shown a second inside exposed view of cylinder (205) with button (210), cam (220), pawl shaft (230) and gear (240) depressed into the body in the second position. Now gear (240) engages the pawl (250) which more forward while the original pawl (250) no longer engages gear (240).

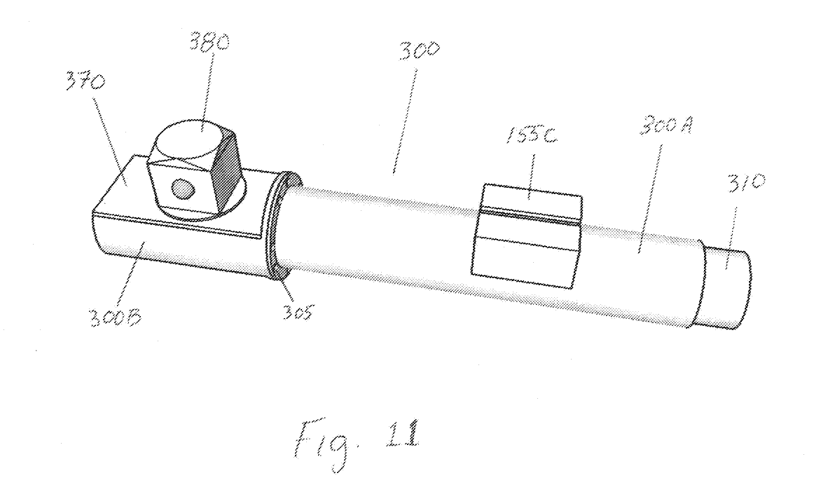

Referring now to FIG. 11, there is shown a bottom perspective view of cylinder body (300). Cylinder body (300A) is attached to mounting bracket (155C) and is further attached to ratchet box (300B). Socket driver (380) is situated transversely on box (300B).

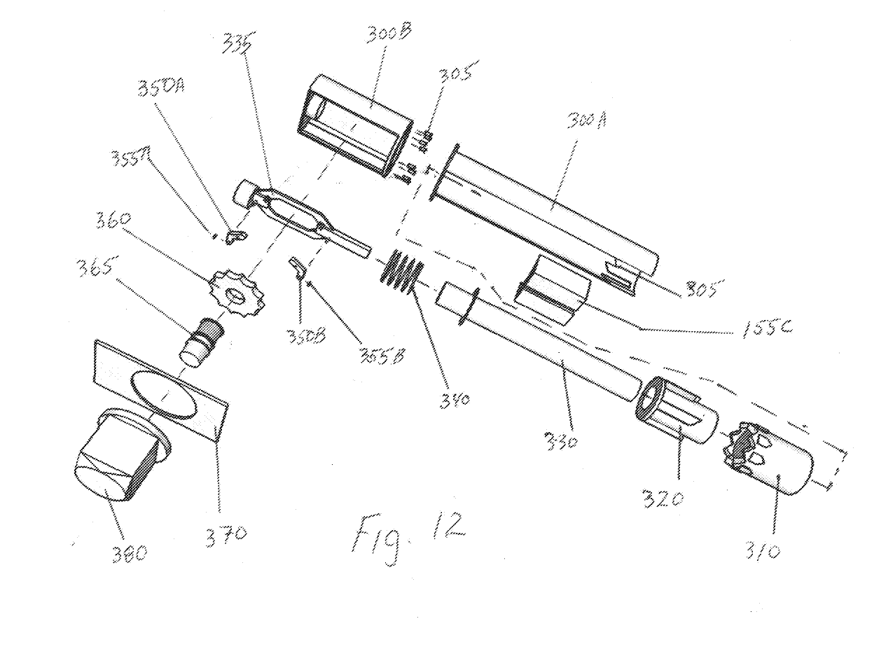

FIG. 12 is a side perspective, inside view of the cylinder body with each of the internal parts exploded with each part identified.

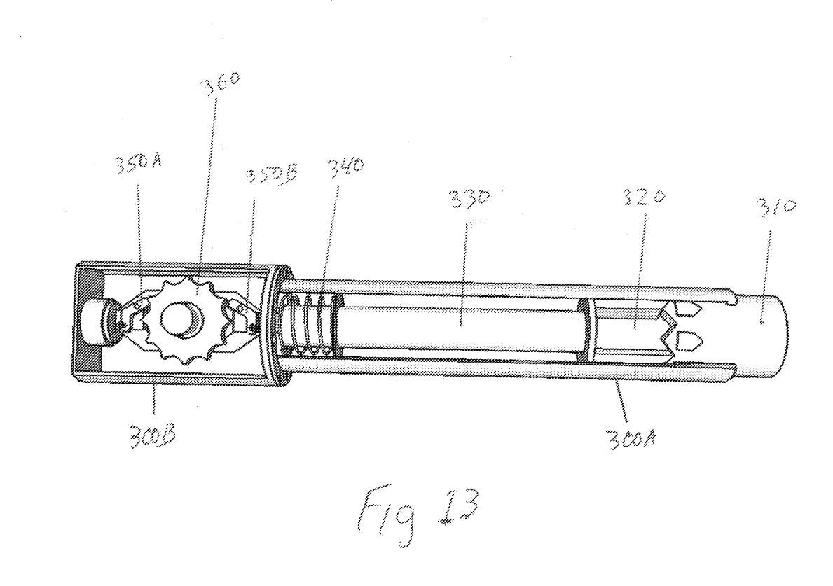

FIG. 13 is a bottom sectional inside exposed view of the cylinder body with the button, cam pawl shaft and pawl holder in the first position.

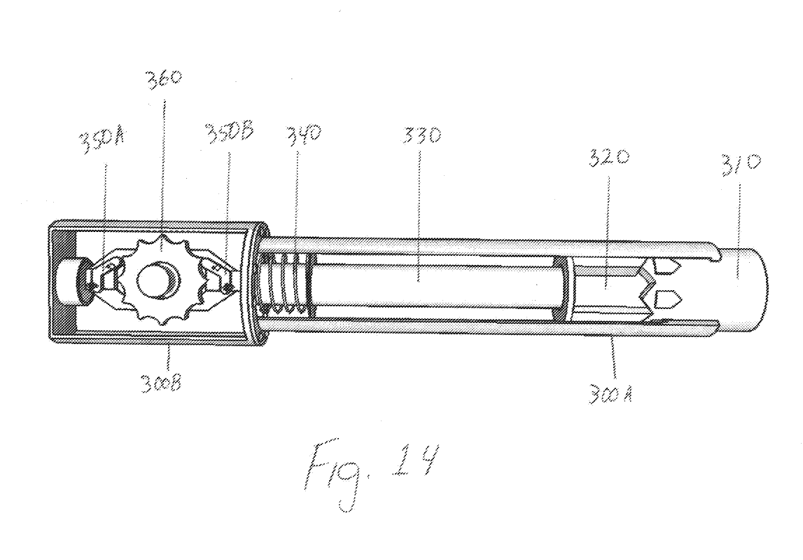

FIG. 14 is a bottom sectional inside exposed view of the cylinder body with the button, cam pawl shaft and pawl holder in the second position.

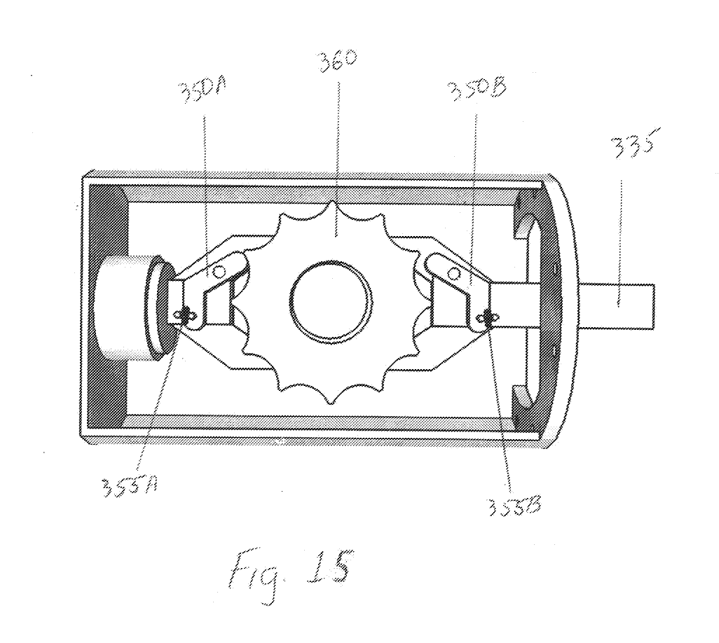

FIG. 15 is a bottom sectional inside detailed exposed view of the cylinder body more clearly depicting the pawl and sprocket connection in the first position.

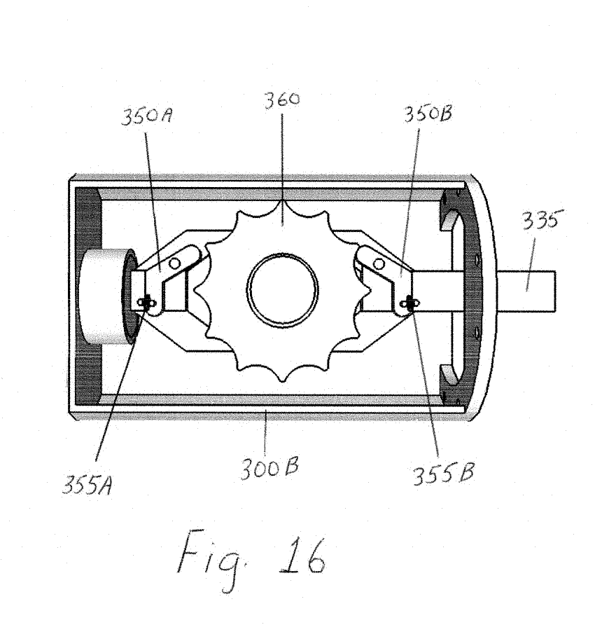

FIG. 16 is a bottom sectional inside detailed exposed view of the cylinder body more clearly depicting the pawl and sprocket connection in the second position.

We claim:

1. A multiuse hand glove comprising:
A surface covering the palm, backside, index and other fingers of the hand of the wearer; a wrist shroud attached to the hand portion extending back from the hand portion covering the wrist of the wearer; a repositionable flap attached transversely between the wrist and palm portions of the glove, said flap having a pocket, said pocket holding a plate made of a suitably hard material; a flap securing means; a flexible metal plate attached to the backside of the glove along the index finger and the back portion of the hand, a detachable, reversible ratchet driver disposed along the backside of the index finger in alignment with the long axis of the hand, said ratchet including a cylindrical body, a forward and reverse toggle mechanism, ratchet means and a coupler for receiving common tool bits for Philips, flat head, hex, star, Allen, socket and other fasteners of the like.

2. The glove of claim 1 wherein said flap when secured in a first position, protects the wrist and when secured in second position, covers the ball of the palm.

3. The glove of claim 1 wherein the plate is made of molded metal.

4. The glove of claim 1 wherein the plate is made of a suitable molded rubber.

5. The glove of claim 1 wherein the first plate is made of a suitable molded plastic.

6. The glove of claim 1 wherein said flap when secured in this second position allows the wearer to impart kinetic impact force on an object by striking said object with the ball portion of the palm.

7. The glove of claim 1 wherein said ratchet consists of a main cylindrical body, said body coupled to the toggle button mechanism, said button having a first position, said button being depressible to a second position, said button again being depressible, released and returned to the first position; a follower cam connected to said button, said cam rotating coaxially inside the body from a first position to a second position, said cam moving along the long axis of the body from a first location to a second location such that the cam remains locked in the second position and in the second location, said cam rotating again when the button is again depressed releasing the cam from said depressed second location returning to its original position.

8. A glove of claim 1 wherein the cylindrical body slides on and off a mounting bracket attached to the metal plate.

9. The glove of claim 7 wherein inside the cylindrical body the toggle button mechanism is coupled to a forward and reversing ratchet means, said means including at least one first directional ratchet pawl, a gear with tapering teeth on each end, at least one second opposite directional ratchet pawl, a tension spring, and a fitting for receiving common tool bits.

10. A glove of claim 9 wherein the fitting is placed coaxially to the long axis of the body and terminates with a female hex-shaped receiving end.

11. A glove of claim 9 wherein the fitting is placed transversely to the long axis of the body and terminates with a male square-shaped socket driver end.

12. A surface covering the palm, backside, index and other fingers of the hand of the wearer; a wrist shroud attached to the hand portion extending back from the hand portion covering the wrist of the wearer; a repositionable flap attached transversely between the wrist and palm portions of the glove, said flap having a pocket, said pocket holding a plate made of a suitably hard material and padding attached thereto; a flap securing means.

13. A reversible ratchet driver, said ratchet including a cylindrical body, a forward and reverse toggle mechanism, ratchet means, and a receiving fitting for receiving common tool bits for Philips, flat head, hex, star, Allen, socket and other fasteners of the like.

14. A reversible ratchet driver of claim 13 wherein the fitting is placed coaxially to the long axis of the body and terminates with a female hex-shaped receiving end.

15. A glove of claim 13 wherein the fitting is placed transversely to the long axis of the body and terminates with a male square-shaped socket driver end.
